(19) United States
(12) Patent Application Publication
(10) Pub. No.: US 2021/0323372 A1
(43) Pub. Date: Oct. 21, 2021

(54) Dual Hydraulic Stabilizer Control Apparatus

(71) Applicants: Remus Vintila, Indianapolis, IN (US); Logan Wagner, Indianapolis, IN (US); Ashley Eimers, Louisville, KY (US); Connor Dall, Greenville, SC (US); Chad Christy, Indianapolis, IN (US)

(72) Inventors: Remus Vintila, Indianapolis, IN (US); Logan Wagner, Indianapolis, IN (US); Ashley Eimers, Louisville, KY (US); Connor Dall, Greenville, SC (US); Chad Christy, Indianapolis, IN (US)

(21) Appl. No.: 16/851,527

(22) Filed: Apr. 17, 2020

(51) Int. Cl. B60G 21/073; F15B 15/14; F15B 15/04

(52) U.S. Cl. CPC B60G 21/073; B60G 1/04; F15B 15/04; F15B 15/1409

(57) ABSTRACT

A vehicle stabilization system is disclosed which include two double-acting hydraulic cylinders of the same size, each attached to a vehicle, chassis and the wheel hub assembly on an axle, each cylinder having a top chamber and a bottom chamber, a hydraulic system which includes two compression chambers disposed between the two double acting cylinders, and hydraulic lines coupling the top chamber of one double-acting hydraulic cylinder to the bottom chamber of the other double-acting hydraulic cylinder, and vice versa, and to the two compression chambers disposed therebetween, movement of a first axel of a first chassis with respect to a second axel of the first chassis causes an increase in pressure in one of the two compression chambers and a decrease in pressure in the other of the two compression chambers, thereby providing a hydraulic coupling between the two axels.

### TECHNICAL FIELD

The present disclosure generally relates to the field of motor vehicles, and in particular, to a system which improves the anti-roll control of the vehicle.

### BACKGROUND

This section introduces aspects that may help facilitate a better understanding of the disclosure. Accordingly, these statements are to be read in this light and are not to be understood as admissions about what is or is not prior art.

Most vehicles have some sort of anti-roll bar or stabilizer. This exists to prevent excessive body sway when taking corners or similar maneuvers and to connect the left and right wheels together. It typically consists of a spring steel bar bent at the ends while the center is supported by the chassis of the vehicle. The ends are connected to the hub assemblies. This technology limits relative movement of the wheels on the same axle. This is a passive system that cannot be adjusted, but in some cases can be completely disconnected.

An anti-roll bar has two main functions: to reduce the body lean and to tune the hanging balance of the car. The body lean of the vehicle is dependent on the total roll stiffness of the vehicle. Altering the total roll stiffness from the front and rear axles can tune out understeer and oversteer behavior.

The major drawback of anti-roll bars is that it can create a rougher ride. The forces on one wheel will transfer to the opposite wheel. On roads that are rough, broken, or plagued by potholes, this can produce an uncomfortable jarring motion and cause wear and tear. The effects of this motion will increase with the diameter and stiffness of the anti-sway bars. When roll stiffness is very high, it can make the inside wheels elevate off the ground during aggressive cornering.

Heretofore multiple anti-roll control apparatuses for use in vehicles have been proposed. No previous disclosures have used dual hydraulic cylinders coupled with expansion chambers and a variable amount of compressible fluid. Recent patents related to a hydraulic stabilizing system, or hydraulic anti-roll bar, include designs from Vieielle, Phillippe et al (199), Ryan, Jeffry S. et al (2011), Jackson, Wayne Peter (2017), and Baltoi, R\check{a}zvan et al (2018). Each of these patents involve some application of a hydraulic or fluid transfer system to better stabilize and reduce roll in commercial vehicles. None of the mentioned patents have been issued in the United States.

Therefore, there is an unmet need for a novel approach to an anti-roll apparatus in a motor vehicle.

### SUMMARY

The primary objective of the present disclosure is to increase four-wheeled vehicle stability by reducing body roll during cornering. The present disclosure would be an improvement on the current anti-roll systems.

The novel apparatus of the present disclosure includes two double acting hydraulic cylinders with hydraulic lines connecting the top chamber of each cylinder to the bottom chamber of the other. Each line would have an expansion chamber attached to it. The volume of the system would be partly filled with an incompressible hydraulic fluid, with the exception of a portion of the volume, which would be filled with a compressible fluid. By varying the amount and pressure of the compressible fluid, the system's effectiveness could be altered.

A vehicle stabilization system is disclosed which includes two double-acting hydraulic cylinders of the same size, each attached to a vehicle, chassis and the wheel hub assembly on an axle, each cylinder having a top chamber and a bottom chamber, a hydraulic system which includes two compression chambers disposed between the two double acting cylinders, and hydraulic lines coupling the top chamber of one double-acting hydraulic cylinder to the bottom chamber of the other double-acting hydraulic cylinder, and vice versa, and to the two compression chambers disposed therebetween, movement of a first axel of a first chassis with respect to a second axel of the first chassis causes an increase in pressure in one of the two compression chambers and a decrease in pressure in the other of the two compression chambers, thereby providing a hydraulic coupling between the two axels.

### BRIEF DESCRIPTION OF DRAWINGS

FIG. 1 is a 2D side view of the apparatus of the present disclosure of two hydraulic cylinders connected by hydraulic lines between two tires. The connections create two distinct and independent hydraulic systems.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

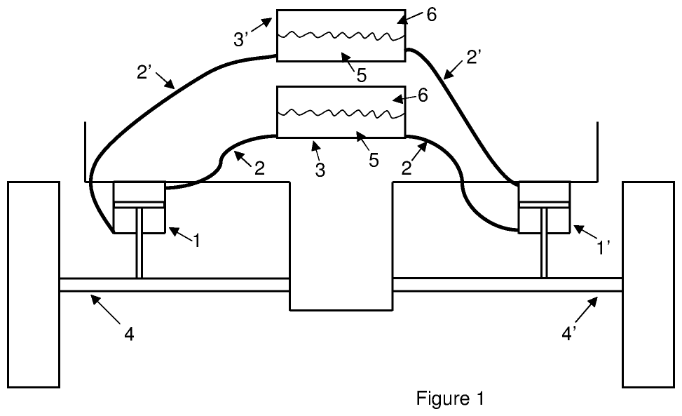

The present disclosure provides a novel approach for anti-roll conditions. The apparatus of the present disclosure is directed to replacing sway bars in front and rear suspensions of a motor vehicle with two double acting hydraulic cylinders thereby hydraulically coupling one axel from the other in each of the suspensions rather than having a mechanical coupling resulting from the sway bars. Referring to FIG. 1, two double acting hydraulic cylinders 1 and 1′ are shown each filled with an incompressible working fluid 5. These cylinders are connected by hydraulic lines 2 and 2′. Each line connects the top chamber of a cylinder to the bottom chamber of the other, creating two distinct and independent hydraulic systems. There are two compression chambers 3 and 3′, each connected to each line. These compression chambers 3 and 3′are partially filled with the same working fluid 5 as the rest of the system, and partly filled with a compressible fluid 6. In the compression chambers 3 and 3′, depending on pressures, the compressible fluid 6 changes volume, so that when pressure drops, the compressible fluid 6 expands in volume and when pressure increases, the compressible fluid contracts in volume.

As differential motion occurs between the two axels (i.e., one axel 4 moves in the vertical direction with respect to other axel 4′, the overall volume of one hydraulic system will increase, while the volume of the other will decrease. The resistance to volume change will be dependent on the volume and pressure of the compressible fluid 6 inside the compression chambers 3 and 3′.

Optionally, an additional line can be installed connecting the two compression chambers, and closed off with a valve, such that when valve is open, then system is hydraulically decoupled. That is, if this valve is opened, the two hydraulic systems are combined, and relative motion of the wheels does not produce a change in the overall volume of the now combined system. This would essentially disable the system, allowing for independent wheel movement, which can be useful in certain off-road conditions, where displacement of the axels 4 and 4′ are desired. The valve can be an electronically controlled valve under control of a processor or by selection of a user.

The pressure of incompressible/compressible fluids 5/6 in each chamber 3 and 3′ when the axels 4 and 4′ are at the same height (i.e., no relative movement therebetween) is between about 10 PSI and 100 PSI, or more particularly between 30 PSI and 70 PSI. The compressible fluid is selected from the group consisting of air, nitrogen, argon, CO₂, combinations thereof, or other compressible fluids known to a person having ordinary skill in the art. The incompressible fluid is typically hydraulic fluid, example, fluid used in brake lines, or other fluids known to a person having ordinary skill in the art.

While the compressible fluid 6 is shown to be at the top portion of the chambers 3 and 3′, it should be appreciated that the compressible fluid 6 and the incompressible fluid 5 may be intermixed in the fluid system of the present apparatus.

Those having ordinary skill in the art will recognize that numerous modifications can be made to the specific implementations described above. The implementations should not be limited to the particular limitations described. Other implementations may be possible.

What is claimed is:

1. A vehicle stabilization system comprising:
two double-acting hydraulic cylinders of the same size, each attached to a vehicle chassis and the wheel hub assembly on an axle, each cylinder having a top chamber and a bottom chamber;
a hydraulic system comprising:
two compression chambers disposed between the two double acting cylinders; and
hydraulic lines coupling the top chamber of one double-acting hydraulic cylinder to the bottom chamber of the other double-acting hydraulic cylinder, and vice versa, and to the two compression chambers disposed therebetween,
wherein, movement of a first axel of a first chassis with respect to a second axel of the first chassis causes an increase in pressure in one of the two compression chambers and a decrease in pressure in the other of the two compression chambers, thereby providing a hydraulic coupling between the two axels.

2. The system of claim 1, wherein incompressible fluid is selected from the group consisting of air, nitrogen, argon, CO₂, or a combination thereof.

3. The system of claim 1, further comprising a valve disposed between the two compression chambers, where opening of the valve results in hydraulic decoupling between the two axels.

4. The system of claim 3, wherein the valve is an electronic valve.

5. The system of claim 1, wherein the hydraulic system has a pressure between about 10 PSI and about 100 PSI when the one first and second axels are aligned with one-another.

6. The system of claim 5, wherein the pressure is between about 30 and about 70 PSI.
